(19) United States
(12) Patent Application Publication
(10) Pub. No.: US 2011/0270691 A1
(43) Pub. Date: Nov. 3, 2011

(54) METHOD AND SYSTEM FOR PROVIDING URL POSSIBLE NEW ADVERTISING

(75) Inventor: Jong Ho Park, Seongnam-si (KR)

(73) Assignee: NHN BUSINESS PLATFORM CORPORATION, Seongsam-si (KR)

(21) Appl. No.: 12/933,679

(22) PCT Filed: Dec. 31, 2008
(86) PCT No.: PCT/KR08/07841

§ 371 Date: Dec. 15, 2010

(30) Foreign Application Priority Data
Mar. 21, 2008 (KR) 10-2008-0026430

(51) Int. Cl. G06Q 30/00

(52) U.S. Cl. 705/14.73

(57) ABSTRACT

Disclosed are a method and system for providing a uniform resource locator (URL) enabling a new advertisement. The method includes acquiring, from a usage record of users using an application, a URL with respect to a site where the users visit, analyzing the URL or a landing page of the URL to classify a category of business with respect to the URL, and providing the URL that enables the new advertisement based on a comparison of a site of the URL with a registered advertisement site or an exposed advertisement site for each of the classified category of business.

### CROSS-REFERENCE TO RELATED APPLICATIONS

This application is the National Stage of International Application No. PCT/KR2008/007841, filed Dec. 31, 2008, and claims priority from and the benefit of Korean Patent Application No. 10-2008-0026430, filed on Mar. 21, 2008, which are both hereby incorporated by reference for all purposes as if fully set forth herein.

### BACKGROUND OF THE INVENTION

1. Field of the Invention

The present invention relates to a method and system for providing a Uniform Resource Locator (URL) enabling a new advertisement, and more particularly, to a method and system for providing a URL enabling a new advertisement that may acquire a usage record of a user using Internet services, and classify commercially available URLs to provide the URL enabling the new advertisement.

2. Discussion of the Background

In general, a Uniform Resource Locator (URL) is a standard indicating locations of a variety of information on the Internet. A web browser using the URL may concurrently support various types of services on the Internet, such as a Hypertext Transfer Protocol (HTTP), File Transfer Protocol (FTP), User's Network (USENET) News, e-mail, gopher, telecommunication network (Telnet), and the like. The URL indicating locations of various types of services may be used to acquire required information from many servers providing the above-mentioned services. The URL may indicate locations of files existing in each server providing services on the Internet, and include a type of a service to be connected with, a location of the server (domain name), a location of the file, and the like. A syntax of the URL may be expressed as ‘protocol://name of a computer having corresponding information/directory name/file name’. For example, the URL may be expressed as “www.ebook.com/Main/default.aspx”.

In general search advertisement services, an advertisement may be exposed one-sidedly to users connecting with a portal search site, or when the user inputs a query intending to search, an advertisement concerning a searched result corresponding to the query may be exposed together with the searched result. However, in a conventional search advertisement service, an advertiser needs to register a search advertisement or an exposed advertisement in advance, and thus advertisement service providers may meet difficulties in increasing advertising revenue when there is no advertiser desiring to register new advertisement services.

Accordingly, there is an urgent need for developing a new business resource for the search advertisement that may acquire a usage record of the user using the Internet services, and provide new advertisement services to thereby achieve advertising effects.

### SUMMARY OF THE INVENTION

An aspect of the present invention provides a method and system for providing a Uniform Resource Locator (URL) enabling a new advertisement that may acquire a usage record of a user using Internet services, and classify commercially available URLs to provide the URL enabling the new advertisement.

According to an aspect of the present invention, there is provided a method for providing a uniform resource locator (URL) to enable a new advertisement, the method including: acquiring, from a usage record of users using an application, a URL with respect to a site where the users visit; analyzing the URL or a landing page of the URL to classify a category of business with respect to the URL; and providing the URL that enables the new advertisement based on a comparison of a site of the URL with a registered advertisement site or an exposed advertisement site for each of the classified a category of business.

According to an aspect of the present invention, there is provided a system for providing a URL to enable a new advertisement, the system including: a URL acquisition unit to acquire, from a usage record of users using an application, a URL with respect to a site where the users visit; a business classification unit to analyze the URL or a landing page of the URL to classify a category of business with respect to the URL; and a URL providing unit to provide the URL that enables the new advertisement based on a comparison a site of the URL with a registered advertisement site or an exposed advertisement site for each of the classified a category of business.

According to the present invention, there are a method and system for providing a Uniform Resource Locator (URL) enabling a new advertisement that may acquire a usage record of a user using Internet services, and classify commercially available URLs to provide the URL enabling the new advertisement, thereby easily developing a new business resource for a search advertisement utilizing Internet advertisement services.

### BRIEF DESCRIPTION OF THE DRAWINGS

FIG. 1 is a diagram illustrating an interworking relation between a system for providing a Uniform Resource Locator (URL) enabling a new advertisement and a user terminal;

FIG. 2 is a diagram illustrating a configuration of a system for providing a URL enabling a new advertisement according to example embodiments of the present invention;

FIG. 3 illustrates an example of embodying a configuration of a URL acquisition unit;

FIG. 4 illustrates an example of embodying a configuration of a business classification unit;

FIG. 5 is a flowchart illustrating a method of providing a URL enabling a new advertisement according to example embodiments of the present invention;

FIG. 6 is a flowchart illustrating a method of embodying a URL acquisition operation, in detail; and

FIG. 7 is a flowchart illustrating a method of embodying a business classification operation, in detail.

### DETAILED DESCRIPTION OF THE ILLUSTRATED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

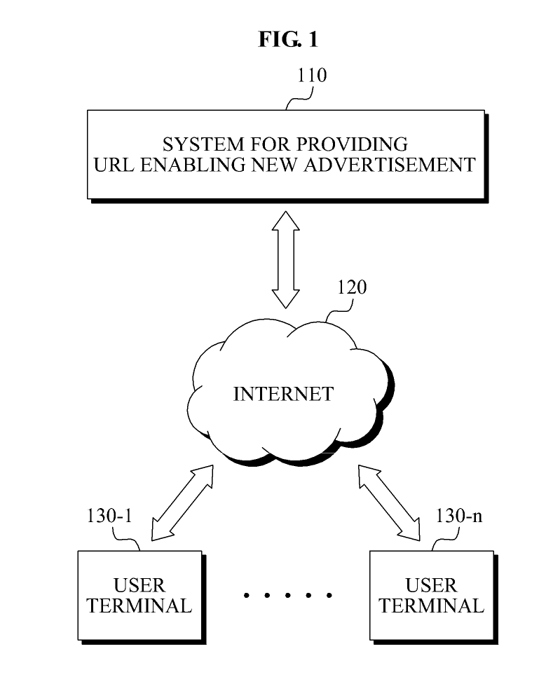

FIG. 1 is a diagram illustrating an interworking relation between a system 110 for providing a Uniform Resource Locator (URL) enabling a new advertisement and a user terminal.

Referring to FIG. 1, the system 110 may acquire a usage record of users using an application from user terminals 130-1 to 130-n connected with the system through the Internet 120. The system 110 may provide Internet services such as a search service, café, blog, dictionary, news, and the like to the users of the user terminals 130-1 to 130-n, and concurrently expose advertisements when providing the Internet services. The application is an application program used when the users are provided with the Internet services through the user terminals 130-1 to 130-n. For example, the application may be any type of application for clients such as a toolbar, an antivirus program, and the like. The toolbar is an application for enabling easy movement to a user's favorite sites or services via a single click using a theme to enable the user to easily use the user's favorite Internet services.

Specifically, the system 110 may acquire the usage record of the user using the application, with respect to the Internet services, from the user terminals 130-1 to 130-n connected with the system through the Internet 120. The usage record of the user may include information generated when the user uses the Internet services, such as a URL of a site where the user visits, a visiting frequency of the site, and the like.

Also, the system 110 may request the user to agree to authentication using the usage record of the user in advance before acquiring the usage record from the user. Also, the system 110 may record and maintain the usage record of the user in a database.

Also, the system 110 may acquire, from the usage record of the user, a URL with respect to a site where the user visits. For example, the system 110 may analyze the usage record of the user recorded in the database to acquire the URL with respect to the site where the user visits.

The system 110 may analyze the URL and a landing page of the URL to classify a category of business with respect to the URL. Specifically, the system 110 may analyze the URL or the landing page of the URL to classify the category of business with respect to the URL using an advertisement object business category.

The system 110 may provide the URL enabling the new advertisement based on a compared result between a site of the URL and a registered advertisement site or an exposed advertisement site for each category of business. Specifically, the system 110 may compare the site of the URL and the registered advertisement site or the exposed advertisement site for each category of businesses, and classify registered URLs or unexposed URLs based on a compared result to provide the URL enabling the new advertisement to an operator of advertisement services. The operator of advertisement services providing the URL enabling the new advertisement may identify a site that does not provide an advertisement through search advertisement, informed shopping, or the like from among popular sites of users to thereby utilize the identified site in advertisement business.

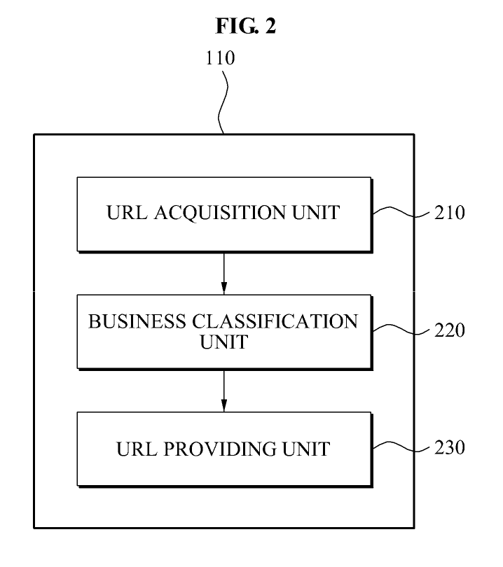

Hereinafter, a specific configuration and operations of the system 110 enabling the new advertisement will be described in detail with reference to FIG. 2.

FIG. 2 is a diagram illustrating a configuration of a system for providing a URL enabling a new advertisement according to example embodiments of the present invention.

Referring to FIG. 2, the system 110 includes a URL acquisition unit 210, a business classification unit 220, and a URL providing unit 230.

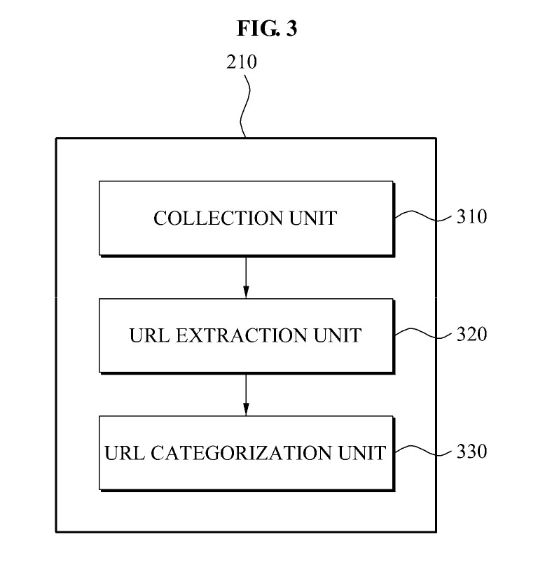

The URL acquisition unit 210 may, from a usage record of users using an application, acquire a URL with respect to a site where the users visit. For example, the URL acquisition unit 210 may analyze a usage record with respect to Internet services of the users using the application from a database where the usage record is recorded and maintained, and acquire a URL with respect to a site where the users visit. Hereinafter, a specific configuration and operations of the URL acquisition 210 will be described in detail with reference to FIG. 3.

FIG. 3 illustrates an example of embodying a configuration of a URL acquisition unit.

Referring to FIG. 3, the URL acquisition unit 210 includes a collection unit 310, a URL extraction unit 320, and a URL classification unit 330.

The collection unit 310 may collect the usage record with respect to the Internet service of the users using the application. For example, the collection unit 310 may collect the usage record with respect to the Internet services, and record and maintain the collected usage record.

The URL extraction unit 320 may analyze the collected usage record to extract the URL with respect to the site where the users visit. Specifically, the URL extraction unit 320 may analyze the collected usage record, and extract a single URL for each site when a plurality of URLs with respect to a single site where the users visit exist.

For example, when the plurality of the URLs with respect to the single site exist such as ‘www.ebook.com, www.ebook.com/main, www.ebook.com/national, www.ebook.com/international, www.ebook.com/bestseller’, the URL extraction unit 320 may extract a representative URL such as ‘www.ebook.com/bestseller’ or a top level URL of a corresponding site such as ‘www.ebook.com’.

The URL classification unit 330 may classify a URL with respect to a site satisfying a predetermined visit condition in the extracted URL. For example, the URL classification unit 330 may classify URLs with respect to sites in which a number of visitors visiting the extracted site of the URL in one day satisfies the predetermined visit condition.

The URL classification unit 330 may classify URLs in which a number of visitors visiting the sites of the URLs is more than a predetermined value, from among the extracted URLs. Specifically, the URL classification unit 330 may classify, as an object candidate for a new advertisement business, URLs in which the number of visitors visiting the site of the URL is more than a minimum reference value exhibiting advertisement effect. For example, the URL classification unit 330 may classify only URLs in which the number of visitors visiting the site of the URL is more than 50 in one day, from among the extracted URLs.

The URL classification unit 330 may classify URLs in which the number of visitors visiting the site of the URL is less than the predetermined value, from among the extracted URLs. Specifically, when the number of visitors visiting the site of the URL is more than a reference value ensured by the search advertisement or knowledge shopping, the URL classification unit 330 may classify, as the object candidate for the new advertisement business, URLs in which the number of visitors visiting the site of the URL is less than the reference value. For example, the URL classification unit 330 may classify only URLs in which the number of visitors visiting the site of the URL is less than 200 in one day, from among the extracted URLs.

The URL classification unit 330 may classify URLs in which the number of visitors visiting the site of the URL is more than a first predetermined value and less than a second predetermined value, from among the extracted URLs. Specifically, the URL classification unit 330 may classify, as the object candidate for new advertisement business, the URLs in which the number of visitors visiting the site of the URL is more than the first predetermined value exhibiting the advertisement effect and less than the second predetermined value ensured by the search advertisement or knowledge shopping. For example, the URL classification unit 330 may classify URLs in which the number of visitors visiting the site of the URL is more than 50 and less than 200 in one day.

The business classification unit 220 may analyze a URL or a landing page of the URL to classify a category of business with respect to the URL. Specifically, the business classification unit 220 may analyze the URL or the landing page of the URL to the category of business with respect to the URL using an advertisement object business category.

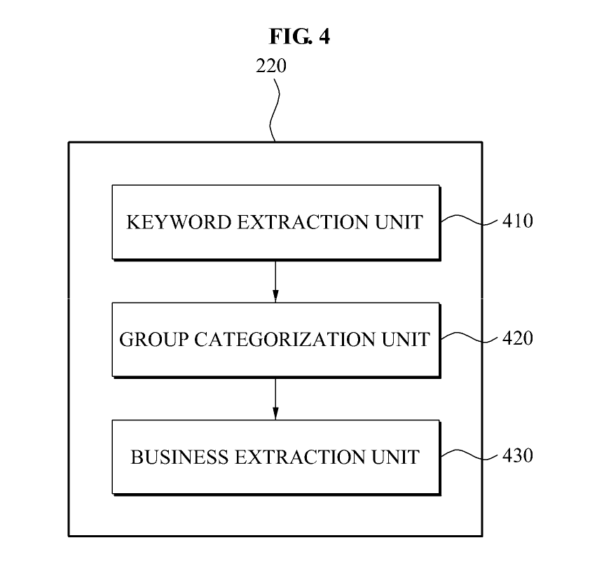

FIG. 4 illustrates an example of embodying a configuration of the business classification unit 220.

Referring to FIG. 4, the business classification unit 220 includes a keyword extraction unit 410, a group classification unit 420, and a business extraction unit 430.

The keyword extraction unit 410 may extract a keyword from the extracted URL or the extracted landing page of the URL. For example, when the extracted URL is ‘www.ebook.com/bestseller’, the keyword extraction unit 410 may extract a keyword such as ‘ebook, bestseller’ from the extracted landing page of the URL. The landing page may be a page linked with an advertisement, that is, a page to which an advertiser desires to move to when the advertiser transmits an advertising message through the advertisement to consumers, and the consumers click on the advertisement. Specifically, the landing page may be a web page most effectively exhibiting the advertising message of the advertiser, which is a main page for each site. For example, the landing page may be a goods list page with respect to an object which the advertiser desires to sell or advertise, a goods selling page, or a web page introducing an event.

The group classification unit 420 may analyze the extracted keyword to classify keywords having similar meanings into a single group. Specifically, the group classification unit 420 may analyze the extracted keyword using a thesaurus to classify keywords having similar meanings into a single group. In this instance, the thesaurus may be obtained by arranging and accumulating keyword groups with similar meanings.

The business extraction unit 430 may compare a keyword group having a highest frequency from the classified keyword groups and a business dictionary to thereby extract a category of the business with respect to the URL. Specifically, the business extraction unit 430 may extract the category of the business with respect to the URL based on a compared result between the keyword group having the highest frequency from the classified keyword groups with a business category and a keyword matching table.

The URL providing unit 230 may provide the URL that enables the new advertisement based on a comparison of the site of the URL with a registered advertisement site or an exposed advertisement site for each of the classified a category of business. The URL providing unit 230 may compare the site of the URL with the registered advertisement site or the exposed advertisement site for each of the classified a category of business, and classify registered URLs or unexposed URLs based on a compared result to thereby provide the URL that enables the new advertisement to an operator of an Internet advertisement.

As described above, the system 110 may acquire the usage record of the users using Internet services, and classify commercially available URLs to provide the URL enabling the new advertisement to the operator of the Internet services, thereby enabling the operator of the Internet services to easily ascertain a new business resource greatly expected to be advertised by the advertiser using the search advertisement or the knowledge shopping.

Accordingly, the system 110 may enable the operator of the Internet services to easily ascertain a URL of a site that does not provide an advertisement through the search advertisement, the informed shopping, or the like from among popular sites of the users, thereby easily performing a new advertisement business.

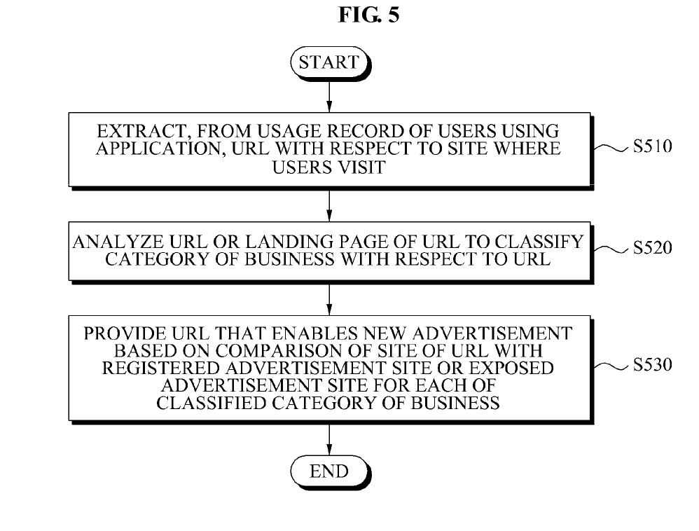

FIG. 5 is a flowchart illustrating a method for providing a URL enabling a new advertisement according to example embodiments of the present invention.

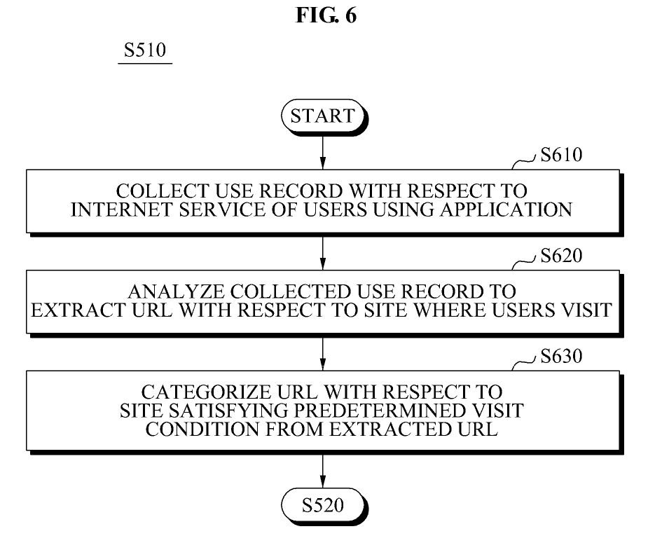

Referring to FIGS. 1 to 5, in operation S510, the system 110 may acquire, from a usage record of users using an application, a URL with respect to a site where the users visit. For example, in operation S510, the system 110 may acquire the usage record of the users with respect to Internet services from user terminals 130-1 to 130-n connected with the system 110 via the Internet 120 to thereby acquire the URL with respect to the site where the users visit, from the usage record of the users with respect to the Internet services. Hereinafter, a specific process of a URL acquisition operation will be described in detail with reference to FIG. 6.

FIG. 6 is a flowchart illustrating a method of embodying the URL acquisition operation, in detail.

Referring to FIGS. 1 to 6, in operation S610, the system 110 may acquire the usage record of the users using the application with respect to the Internet services. For example, in operation S610, the system 110 may acquire the usage record of the users with respect to the Internet services, and record and maintain the acquired usage record of the users in the database.

In operation S620, the system 110 may analyze the acquired usage record to extract the URL with respect to the site where the users visits. Specifically, the system 110 may analyze the acquired usage record of the users, and extract a single URL for each site when a plurality of URLs with respect to a single site where the users visit exist. For example, when a plurality of URLs with respect to a single site where the users visit exist, such as ‘www.ebook.com, www.ebook.com/main, www.ebook.com/national, www.ebook.com/international, www.ebook.com/bestseller’, the system 110 may extract a representative URL of a corresponding site such as ‘www.ebook.com/bestseller’ or a top level URL of a corresponding site such as ‘www.ebook.com’.

In operation S630, the system 110 may classify URLs with respect to sites satisfying a predetermined visit condition in the extracted URLs. For example, in operation S630, the system 110 may classify, as an object candidate for a new advertisement business, a URL with respect to a site in which a number of visitors visiting a web site of the extracted URL in one day satisfies the predetermined visit condition. For example, in operation S630, the system 110 may classify URLs in which the number of visitors visiting the site of the URL is more than a predetermined value from among the extracted URLs. For example, in operation S630, the system 110 may classify, as the object candidate for the new advertisement business, a URL in which the number of visitors visiting the site of the URL is more than 50 in one day from among the extracted URLs.

As an example, in operation S630, the system 110 may classify URLs in which the number of visitors visiting the site of the URL is less than a predetermined value from among the extracted URLs. For example, in operation S630, the system 110 may classify, as the object candidate for the new advertisement business, a URL in which the number of visitors visiting the site of the URL is less than 200 in one day from among the extracted URLs. In operation S630, the system 110 may classify URLs in which the number of visitors visiting the site of the URL is more than a first predetermined value and less than a second predetermined value from among the extracted URLs. For example, in operation S630, the system 110 may classify, as the object candidate for the new advertisement business, a URL in which the number of visitors visiting the site of the URL is more than 50 and less than 200 in one day from among the extracted URLs.

In operation S520, the system 110 may analyze the URL or a landing page of the URL to classify a category of business with respect to the URL

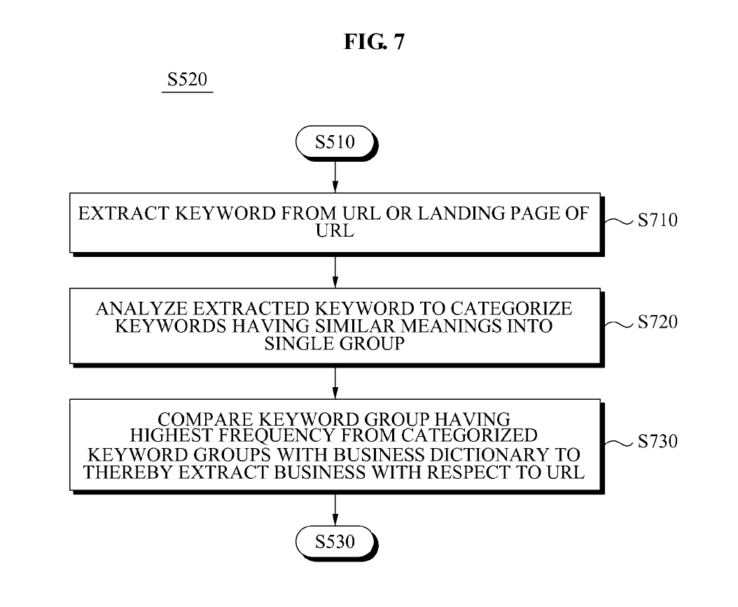

Specifically, in operation S520, the system 110 may analyze the URL or the landing page of the URL to classify the category of business with respect to the URL using an advertisement object business category. Hereinafter, a specific process of a business classification operation with respect to a URL will be described in detail with reference to FIG. 7.

FIG. 7 is a flowchart illustrating a method of embodying the business classification operation, in detail.

Referring to FIGS. 1 to 7, in operation S710, the system 110 may extract a keyword from the URL or the landing page of the URL.

As an example, in operation S710, when the extracted URL is ‘www.ebook.com/bestseller’, the system 110 may extract a keyword of ‘ebook, bestseller’ from the URL, or may extract a keyword from the landing page of the extracted URL.

As an example, in operation S710, when the extracted URL is ‘www.ebook.com’, the system 110 may extract a keyword of ‘ebook’, or may extract a keyword from the landing page of the extracted URL.

In operation S720, the system 110 may analyze the extracted keyword to classify keywords having similar meanings into a single group. Specifically, in operation S720, the system 110 may analyze the extracted keyword using a thesaurus to classify the keywords having similar meanings into the single group. In this instance, the thesaurus may be obtained by arranging and accumulating keyword groups with similar meanings.

In operation S730, the system 110 may compare a keyword group having a highest frequency from the classified keyword groups and a business dictionary to thereby extract a category of the business with respect to the URL. Specifically, in operation S730, the system 110 may extract the category of the business with respect to the URL based on a compared result between the keyword group having the highest frequency from the classified keyword groups with a business category and a keyword matching table.

In operation S530, the system 110 may provide the URL that enables the new advertisement based on a comparison a site of the URL with a registered advertisement site or an exposed advertisement site for each of the classified a category of business. Specifically, in operation S530, the system 110 may compare the site of the URL and the registered advertisement site or the exposed advertisement site for each of the classified a category of business, and classify registered URLs or unexposed URLs based on a compared result to provide the URL that enables the new advertisement to an operator of advertisement services.

As described above, according to the method of providing the URL, the usage record of the users using Internet services may be acquired to classify commercially available URLs, and provide the URL enabling the new advertisement to an operator of an Internet advertisement, thereby enabling the operator of the Internet advertisement to easily ascertain a new business resource highly expected to be advertised by an advertiser using the search advertisement or the informed shopping.

As a result, the operator of the Internet services may be enabled to easily ascertain a URL of a site that does not provide an advertisement through the search advertisement, the informed shopping, or the like from among popular sites of the users, thereby easily performing a new advertisement business.

The method of providing the URL according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for providing information of an advertising opportunity associated with a uniform resource locator (URL), the method comprising:
receiving, from a user application usage record, a URL information with respect to a frequency of visiting sites by the user;
analyzing the URL information or a landing page of the URL visited by the user to classify a category of business with respect to the URL; and
providing the information of the advertising opportunity associated with the URL information, the information of the advertising opportunity being capable of enabling new advertising models by checking the analyzed URL information whether the analyzed URL information comprises a registered advertisement site or an enabling advertisement site with respect to the classified business.

2. The method of claim 1, further comprising:
collecting the user application usage record with respect to Internet services of the user using the application;
analyzing the collected user application usage record to extract the URL information with respect to the site where the user visits; and
classifying URLs with respect to a site satisfying a predetermined visit condition associated with the user application.

3. The method of claim 2, wherein the analyzing of the collected user application usage record further comprises extracting a single URL for each site by analyzing the collected user application usage record, the extraction comprises a plurality of URLs with respect to a single site where the user visits.

4. The method of claim 2, wherein the classifying of the URL information further comprises classifying the URL information if a number of visitors visiting sites of the URLs is more than a threshold value.

5. The method of claim 2, wherein the classifying of the URL information further comprises classifying the URL information if a number of visitors visiting sites of the URLs is less than a threshold value.

6. The method of claim 2, wherein the classifying of the URL information further comprises classifying the URL information if a number of visitors visiting sites of the URLs is more than a first threshold value and less than a second threshold value.

7. The method of claim 1, wherein the analyzing the URL information associated with the landing page of the URL further comprises classifying the businesses with respect to the URL using an advertisement object business category.

8. The method of claim 1, wherein the analyzing of the URL information associated with the landing page of the URL further comprises:
extracting a keyword from the URL information or the landing page of the URL information;
analyzing the extracted keyword to classify keywords by categorizing similar meanings to the extracted keyword into a group; and
comparing a keyword group having a highest frequency based on the classified keyword groups and a business dictionary to extract a category of the business with respect to the URL information.

9. The method of claim 8, wherein analyzing the extracted keyword analyzes the extracted keyword using a thesaurus to classify the keywords having similar meanings into the group, and wherein the thesaurus is obtained by arranging and accumulating keyword groups with similar meanings.

10. The method of claim 8, wherein the comparing a keyword group further comprises extracting the category of the business with respect to the URL by comparing result between the keyword group having the highest frequency from the classified keyword groups with a business category and a keyword matching table.

11. The method of claim 1, further comprising:
providing a classification of a registered or unexposed URL by comparing the site of the URL with the registered advertisement site or the exposed advertisement site with respect to the classified business to provide the URL that enables a new advertisement.

12. A non-transitory computer-readable recording medium comprising an executable program, which when executed, performs of the steps of claim 1.

13. A system for providing information of an advertising opportunity associated with a uniform resource locator (URL), the system comprising:
a URL acquisition unit to acquire, from a user application usage record, a URL information with respect a frequency of visiting sites by the user;
a business classification unit to analyze the URL information or a landing page of the URL information visited by the user to classify a category of business with respect to the URL information; and
a URL providing unit to provide information of an advertising opportunity associated with the URL information, the information of the advertising opportunity being capable of enabling new advertising models by checking the analyzed URL information whether the analyzed URL information comprises a registered advertisement site or an enabling advertisement site with respect to the classified business.

14. The system of claim 13, further comprising:
a collection unit to collect the user application usage record with respect to Internet services of the user using the application;
a URL extraction unit to analyze the collected user application usage record to extract the URL with respect to the site where the user visits; and
a URL classification unit to classify URLs with respect to a site satisfying a predetermined visit condition associated with the user application.

15. The system of claim 14, wherein the URL extraction unit extracts a single URL for each site by analyzing the collected user application usage record, the extraction comprises a plurality of URLs with respect to a single site where the user visit.

16. The system of claim 14, wherein the URL classification unit classifies the URL information if a number of visitors visiting sites of the URLs is more than a threshold value.

17. The system of claim 14, wherein the URL classification unit classifies URL information if a number of visitors visiting sites of the URLs is less than a threshold value.

18. The system of claim 14, wherein the URL classification unit classifies URL information if a number of visitors visiting sites of the URL information is more than threshold value.

19. The system of claim 13, wherein the business classification unit analyzes the URL information or the landing page of the URL information to classify the businesses with respect to the URL information using an advertisement object business category.

20. The system of claim 13, further comprising:
a keyword extraction unit to extract a keyword from the URL information or the landing page of the URL;
a group classification unit to analyze the extracted keyword to classify keywords by categorizing similar meanings to the extracted keyword into a group; and
a business extraction unit to compare a keyword group having a highest frequency based on the classified keyword groups and a business dictionary to extract a category of the business with respect to the URL information.

21. The system of claim 20, wherein the group classification unit analyzes the extracted keyword using a thesaurus to classify the keywords having similar meanings into the group, and wherein the thesaurus is obtained by arranging and accumulating keyword groups with similar meanings.

22. The system of claim 20, wherein the business extraction unit extracts the category of the business with respect to the URL information based on a compared result between the keyword group having the highest frequency from the classified keyword groups associated with a business category and a keyword matching table.

23. The system of claim 13, wherein the URL providing unit classifies a registered or an unexposed URL information based on the comparison of the site of the URL associated with the registered advertisement site or the exposed advertisement site for each of the classified a category of business to provide information of an advertising opportunity associated with the URL information.
